(19) United States
(12) Patent Application Publication
(10) Pub. No.: US 2008/0226435 A1
(43) Pub. Date: Sep. 18, 2008

(54) LOADING AND UNLOADING APPARATUS FOR TRAILER BODY

(76) Inventors: Gregory S. Patterson, Morrisville, NC (US); W. Kevin Carpenter, Warrensville, NC (US); Glen Weichold, Blue Springs, MO (US)

Correspondence Address: HUSCH BLACKWELL SANDERS LLP, 4801 Main Street, Suite 1000, KANSAS CITY, MO, 64112, US

(21) Appl. No.: 11/686,440

(22) Filed: Mar. 15, 2007

(51) Int. Cl. B65G 67/02

(52) U.S. Cl. 414/377

(57) ABSTRACT

A loading and unloading apparatus adapted for use on a wheel-supported trailer body is provided. The loading and unloading apparatus comprises a plurality of elongate support arms, a plurality of channels under the floor structure of the trailer body allowing the support arms to be mounted thereon and move longitudinally between a stored position and an operating position, at least one deck panel having two opposite end edge portions and means for securing the opposite end edge portions to the support arms. The opposite end edge portions are detachably mounted on the support arms.

### BACKGROUND OF INVENTION

The present invention relates generally to a load platform, more particularly, to an improved supporting mechanism for use on vehicles such as a truck body or semi-trailer body.

Load platforms for a truck liftgate or tailgate are well known. A load platform for truck bodies or trailers typically is a part of a liftgate or a loading dock. In the field of power operated loading and unloading equipment or apparatus for use on a truck body or a semi-trailer body, there are many different types of loaders which mount on the rear portion of the vehicle body for use in connection with a doorway opening at the rear of the body. The load platform mounted at the rear end or tailgate of the truck in a manner to be movable between transit and load bearing (working) positions typically comprises a fixed pair of opposite side members, a foldable lift platform, a ramp and a pair of support arms connected to the lift platform and operatively associated with a power means, wherein the support arms connect opposite side members and the lift platform and the power means is drivingly interconnected between the linkage systems and the load platform to effect selective raising and lowering of the platform.

While the current load platform for vehicles are effective for their purposes, they do have certain deficiencies. Load platforms have been developed which allow the platforms to be positioned for a door within a side wall of the cargo body and for the loading apparatus to be carried by the truck or trailer body without adding to the overall width of the body. Accordingly, a loading and unloading apparatus for a vehicle that allows a load platform to be positioned for a door within a side wall of the cargo body without adding to the normal overall width of the body would be advantageous. However, even other types of load platforms which allow flexibility of use have complex configurations and/or require substantial space under the floor structure of the trailer body to be stored when not in use. For example, some vehicles do not have enough space under the bed of the vehicles due to the complex structure of the parts of the vehicles. Load platforms with simple configurations and that require less storage space would be preferable for a truck body, semi-trailer body or railroad cars.

Some load platforms that fold up with the truck body or are stored under the bed of the truck add overall height or width of the body. It is often difficult to manufacture and operate the lifting or swing system for the platform to be movable between a transit position and a load bearing or use position.

Specific examples in the prior art illustrate these deficiencies.

U.S. Pat. No. 4,627,784 issued to Collins attempted to solve several of these problems associated with rail lifts in connection with side doors of railroad cars. The Collins rail lift discloses a “swing-away” lift apparatus. In this device, the lift rails and platform swing as a unit to a position parallel and slightly beneath the plane defined by the railroad car bed. The whole assembly is pushed under the bed of the railroad car to be stored when not in use. The device is located on the side of the railroad car at the car's approximate midpoint. However, this device is not practical in many cases since there is limited room beneath the bed of many vehicles due to placement of other parts including load bearing beams. Further, this lift is very complicated in its operation and storage.

U.S. Pat. No. 5,026,243 issued to Dell discloses an example of a more flexible loading system. The Dell platform discloses a loading or unloading platform which is located and secured in a frame mounted beneath the bottom of a semi-trailer. The platform is removable from underneath the semi-trailer by releasing a lock and pulling the platform out from under the trailer after extension of the retractable wheels of the platform. The platform is then available for use in a locked position adjacent to any door of the semi-trailer. However, this reference fails to provide a load platform of a simple structure which can be stored in a small storage space for transit. Further, the configuration of a ground support mounting system would be difficult to manufacture and use.

U.S. Pat. No. 4,002,106 issued to Edmo discloses a liftgate whose load platform remains substantially horizontal during raising and lowering and which at ground level is capable of tilting the platform to bring its rear edge into engagement with the ground thus providing a ramp. However, this reference fails to provide a load platform in a simple configuration and operation. The device is relatively complex in that it employs two pairs of hydraulic cylinders, one pair of which provides the power to raise and lower the platform. The other relatively complex pair of cylinders provides the power for a tilting action of the platform.

U.S. Pat. No. 4,479,753 issued to Thorley discloses a retrofittable wheelchair lift for passenger vehicles. The lift assembly is hinged on a vertical axis to a door post adjacent the door hinge. When the door opens, the lift assembly pivots away from the door opening. A horizontal carrier slides farther outwardly so that the lift assembly clears the side of the trailer body. A single telescoping vertical carrier is deployed by a hydraulic actuator to lower a platform which then rotates away from the vertical carrier along a horizontal hinge located at the lower edge of the vertical carrier. This lifting apparatus is mounted onto the door of the trailer body which restricts both the weight of lifting apparatus and the amount of weight that can be supported.

Some devices involve an undue multiplicity of separately attached sets of hardware which are therefore relatively expensive and, as the hardware sets are carried in exposed positions, they are prone to being damaged, and thus entail maintenance expense.

There is thus a need for an improved load platform. The present invention provides an advance in the art by providing a modular platform with a simple structure.

Further, it would be desirable to provide the driver a sure-footed walk surface to work more efficiently, enhancing productivity and safety.

It would be also desirable to provide a platform which is substantially level or coextensive with cargo body floor surface so that it provides drivers and workers smooth transitions when loading and off-loading. This provides smooth transition to the platform.

Further objectives and advantages of the present invention will become apparent from a careful reading of a detailed description provided hereinbelow, with appropriate reference to the accompanying drawings.

### SUMMARY OF INVENTION

The present invention in one embodiment involves the provision of a loading and unloading apparatus adapted for use on a wheel-supported trailer body such as a cargo truck or trailer body. The loading apparatus of the present invention generally works at a side door position. The loading and unloading apparatus comprises a plurality of elongate support arms, a plurality of channels under the floor structure of the trailer body allowing the support arms to be mounted thereto and move longitudinally between a stored position and an operating or working position, at least one deck panel having two opposite end edge portions and means for securing the opposite end edge portions to the support arms. The opposite end edge portions are detachably mounted on the support arms. The deck panels may be stored in a container located under the trailer or in a separate place when the loading apparatus is not in use. The apparatus may also include a ramp. The deck panels can accommodate the ramp that preferably parallels the trailer on both sides of the deck panel. The support arms, whose axes are generally parallel, are spaced arms which comprise detents affixed at the distal end of the elongate support arms and grips affixed at the distal end of said elongate support arms. The deck panel generally comprises anti slip plates, such as tread plate of metal or perforated sheet of metal. The symmetrical assembly design of one embodiment of the present invention allows easy staging and stowing.

### BRIEF DESCRIPTION OF DRAWINGS

FIG. 1 is a fragmentary perspective view of a wheel supported trailer body or semi-trailer equipped with loading apparatus constructed in accordance with the invention and with portions of the loading apparatus shown in its retracted storage position.

FIG. 2 is a fragmentary perspective view of the trailer body and loading apparatus after the support arms are extended for loading or off-loading.

FIG. 3 is a fragmentary perspective view of the trailer body and loading apparatus after the platform panels are mounted on the supports in their operating positions in accordance with one embodiment of the present invention.

FIG. 4 is a fragmentary perspective view of the platform panel in accordance with one embodiment of the present invention.

FIG. 5 is a fragmentary perspective view of the trailer body and loading apparatus after the platform panels are mounted on the supports and the ramp are mounted on the platform in their operating positions in accordance with one embodiment of the present invention.

FIG. 6 is a fragmentary perspective view of the platform panel in accordance with second embodiment of the present invention.

FIG. 7 is a fragmentary perspective view of the support arm in accordance with second embodiment of the present invention.

FIG. 8 is a fragmentary perspective view of the trailer body and loading apparatus after the platform panels are mounted on the supports in their operating positions in accordance with second embodiment of the present invention.

FIG. 9 is a fragmentary perspective view of the support arm in accordance with second embodiment of the present invention.

It should be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted. It should be understood, of course, that the invention is not necessarily limited to the particular embodiments illustrated herein. Like numbers utilized throughout the various Figures designate like or similar parts or structure.

### DETAILED DESCRIPTION

Before describing the present invention, it will be understood that variations of the disclosed structure may be applied in combination with various vehicles, and it is not limited to the specific examples described herein.

The phrase “channels mounted to a (the) floor structure” used in the present application refers to the channels being either under or within the floor structure depending on the configuration of the floor structure. For simplicity, the term floor will be used for floor structure. The floor includes the floor deck and support structure therefor.

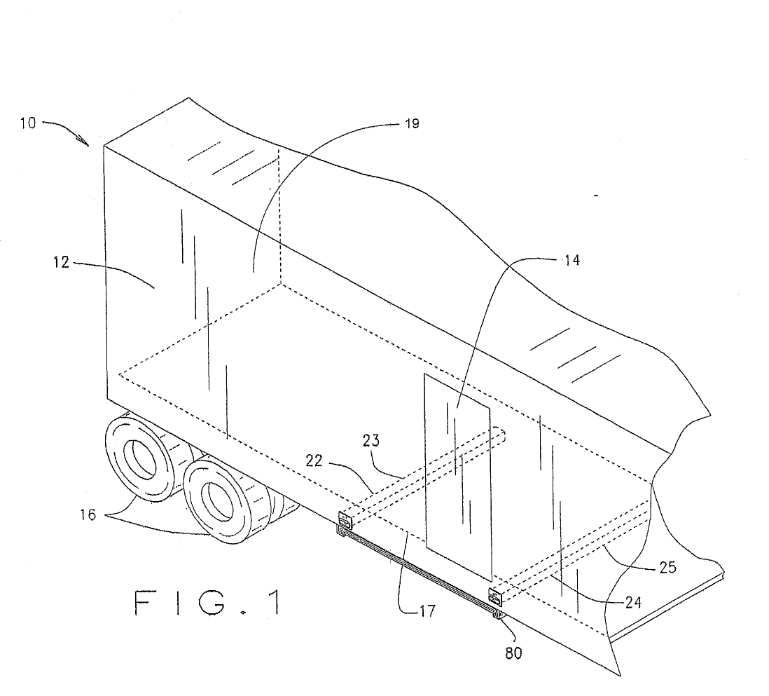

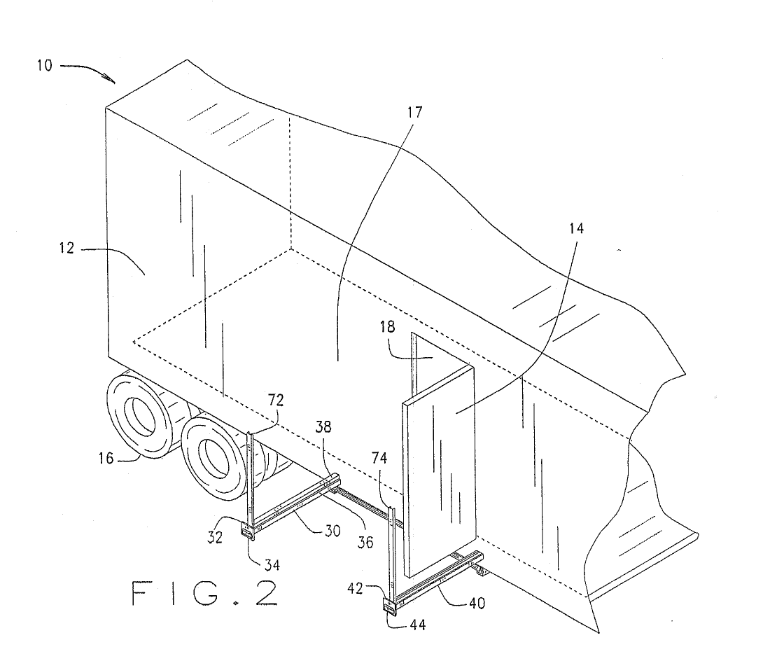

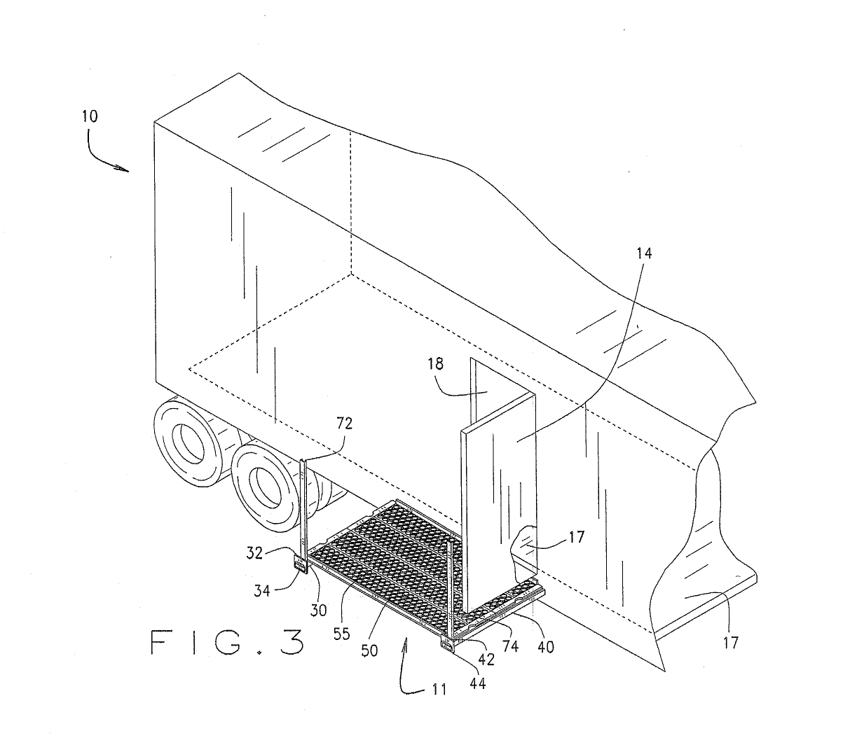

Referring to FIGS. 1-3, the loading and off-loading deck structure 11 is illustrated as only portions at the side door 14 position of a truck of body 12 of trailer body 10. The structure 11 includes a plurality of elongate support arms 30, 40, a plurality of channels 22, 24 under the floor structure 17 or within the floor structure 17 of the cargo trailer body 10 allowing the respective support arms 30, 40 to be mounted therein and move longitudinally along their length between a stored position, FIG. 1, and an operating or working position, FIG. 2, and at least one deck panel 50. FIG. 1 illustrates a semi-trailer body 12 which is supported by one or more sets of wheels 16 and has a side wall 19 with an opening 18 normally closed by one or more doors 14. The channels 22, 24 are shown in dash lines. The door 14 may be pivotal, sliding or rollup. Referring to FIGS. 3 and 5, the loading and unloading structure 11 is shown in an operative condition of its platform ready for use in loading and unloading freight between ground level and a deck 50 in the cargo body 12. The cargo body 12 has a floor support system which has laterally extending channels 22, 24 mounted therein. In accordance with the present invention, the support arms 30, 40 of the apparatus 11 are supported in a stored position under the floor structure 17 of the body 12 and are preferably enclosed within a respective chamber 23, 25 defined under the floor structure 17.

While an enclosed cargo body 12 is shown, it is to be understood that the body 12 can be open or semi-open, e.g., a livestock trailer, in which event, the door 14 can be in the form of a gate or removable panel.

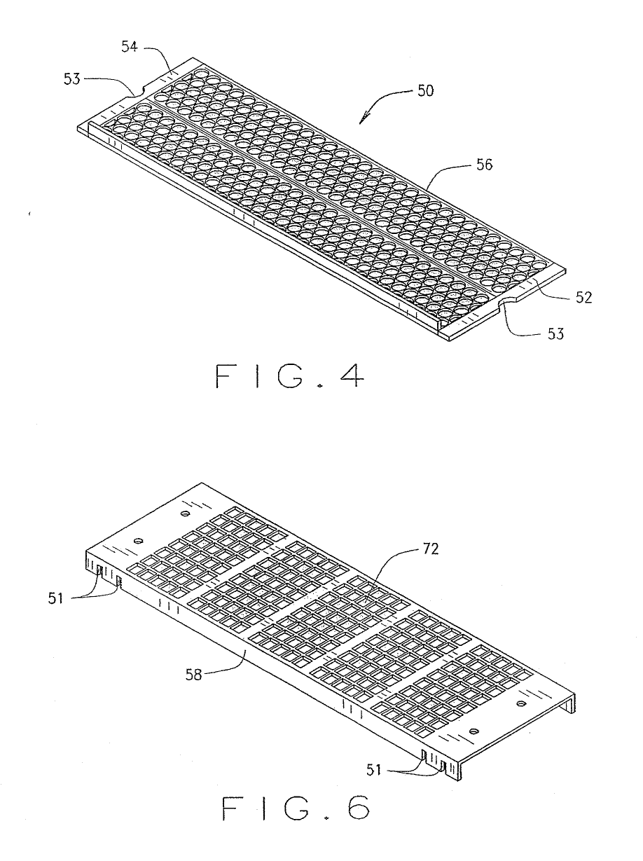

Referring to FIG. 4, the loading apparatus 11 includes at least a pair of generally parallel spaced channels 22, 24 which extend laterally under the floor structure 17 so that the support arms 30, 40 may move transversely of the trailer body 12 from retracted positions to operating positions. The channels 22, 24 are arranged to guide the support arms 30, 40 in a manner that the working surface 55 is substantially horizontal and the working surface 55 of the deck panel 50 and the floor surface 17 of the trailer body 12 are substantially generally coplanar. When extended, as seen in FIG. 2, the arms 30, 40 are suspended in a cantilever manner and sufficient length of each remains in a respective channel 22, 24 to allow the deck panels 50 to be supported by the support arms 30, 40 when the apparatus 11 is in its working position. In one embodiment, the two parallel spaced channels 22, 24 can be mounted at different elevations. In a second embodiment, an additional support arm, not shown, can be employed to provide additional support of a long deck panel. The additional support arm consists of as many plank-sections as needed to provide the desired working area. Referring to the FIGS. 1 and 3, as shown, the right support arm 40 is higher than the left support arm 30, as seen in FIG. 3. An elongate spacer 38 is, in a preferred embodiment, detachably mounted on the left support arm 30 to support the left end portion of the deck panels 50 in a manner that the working surface 55 of the deck panels 50 is substantially horizontal. In one embodiment, the spacer 38 can be secured to the upper surface of the left arm 30 by a locking mechanism, such as a latch (not shown). In an alternative embodiment, the upper surface of the left support arm 30 can be configured to have a slot or groove 36, as a means of receiving and removably retaining the spacer 38. The groove 36 is open in the direction towards the overlying deck panels 50, generally upwardly. The groove 36 could extend along the upper region of the support arm 30 in its longitudinal direction. A length of the groove 36 which lies at the upper region of the support arm 30 is preferably shorter than the length of the support arm 30. The bottom portion of the spacer 38 can be inserted in and removed from the groove 36 when the spacer 38 is moved into a ready-to-use position. The spacer 38 is detachably mounted onto the arm 30 and is positioned in the groove 36. When the spacer 38 holds the deck panel 50 at the rear portion of the support arm 30, end posts 72, 74 hold the opposite side edges of the deck panel 50 against lateral movement. A function of this spacer 38 is to help to hold the deck panel 50 in a manner that the working surface 55 is substantially horizontal. In an alternative embodiment, if both support arms 30, 40 are mounted at the same elevations, the spacer 38 could be dispensed with.

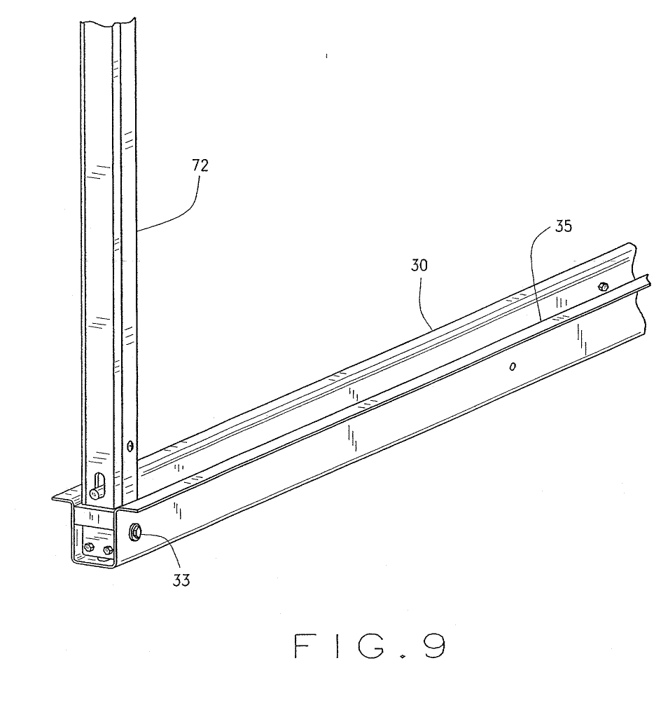

Each channel 22, 24 is formed to closely fit the outer periphery of the each support arm 30, 40. Alternatively, rails, not shown, can be rigidly affixed inside the channels 22, 24 to facilitate movement of the support arms 30, 40. Users can pull the support arms 30, 40 out of the channels 22, 24 using grips 34, 44 rigidly affixed at the respective distal end of each of the support arms 30, 40. When the loading apparatus 11 is in a ready-to-use position as shown in FIG. 3, the inward movement of the support arms 30, 40 is restricted by the deck panels 50 and/or end posts 72, 74 projecting from the distal end portion of each support arm 30, 40. In one embodiment, the support arms 30, 40 consist of several nested sections which telescope out of the stowed configuration. The end posts 72, 74 are detachably mounted on the distal end of each of the support arms 30, 40 and can be stored with the deck panels 50, e.g. under the floor structure 17 of the cargo body 12. Alternatively, the end posts 72, 74 and deck panels 50 can be stored inside the cargo body 12. In one embodiment, the end posts 72, 74 may be pivoting posts which can be stored in the groove 35 of each support arm 30, 40 as shown in FIG. 9. The upwardly open groove 35 is formed on the upper surface of the support arms 30, 40. The end posts 72, 74 pivot about a hinge 33. These structures of the support arms 30, 40 are most useful when the channels 22, 24 may be mounted directly beneath the floor structure 17 of the cargo body 12.

When the loading apparatus 11 is retracted to the stored position, the movement of the support arms 30, 40 is restricted by stops 32, 42 of the support arms 30, 40. Further, frictional force between the inner surfaces of the channels 22, 24 and the outer surfaces of the support arms 30, 40 can inhibit the movement of the support arms 30, 40 when the loading apparatus 11 is not in use. Additionally, a locking mechanism (not shown) may be provided to hold the support arms 30, 40 in their retracted position. The support arms 30, 40 can be fixed in a variety of different extended positions depending on the user's desires. The support arms 30, 40 are slidably movable relative to their respective channel 22, 24 to effect adjustment of the width of the platform formed by the loading deck panels 50. Alternatively, a locking mechanism may be provided to hold the support arms 30, 40 in a pre-selected position in the channels 22, 24. Acceptable locking mechanisms will be readily apparent to those skilled in the art. Another locking mechanism may be provided to keep the support arms 30, 40 from coming out of the stored position. A stop may be provided to keep the support arms 30, 40 from being pulled out. The support arms 30, 40 are movably mounted in the channels 22, 24 which function as guides and support for longitudinal movement. The support arms 30, 40 can be configured in a variety of shapes. In further embodiment, the end posts 72, 74 which project upwardly from the distal end from a respective support arm 30, 40 can be mounted in upstanding relationship to the support arms 30, 40 and be detachable. The posts 72, 74 are then detachably affixed to the respective support arm 30, 40 by suitable locking means, such as a latch or pin and socket. In an alternative embodiment, the posts 72, 74 can be arranged to hold or support the deck panels 50 in a manner that the working surface 55 is substantially horizontal. Specifically, the end post 72 of the left support arm 30 holds the deck panel 50 to keep it in the substantially horizontal position.

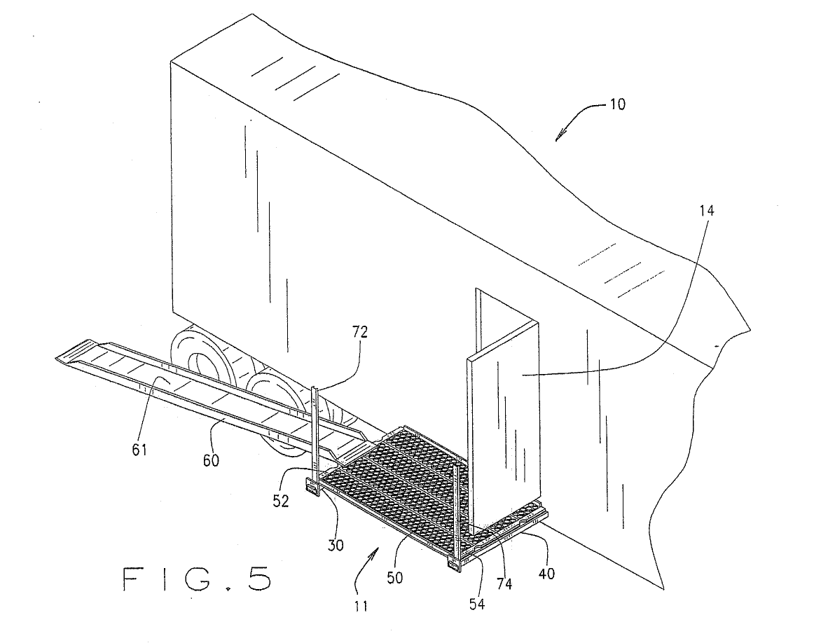

Referring to the FIGS. 4 and 6, the deck panels 50 are shown at their top surfaces forming a relatively flat floor surface which has two opposite end edge portions 52, 54 and are detachably mounted on the support arms 30, 40 by at least one recess and/or the spacer 38. The end edge portions 52, 54 are configured to define at least one recess 53 to be secured to the support arms 30, 40 directly or via the spacer 38. In one embodiment, the end edge portions 52, 54 comprise notches 51 at the bottom surface of the end edge portions 52, 54. As FIG. 6 illustrates, in further embodiment, peripheral skirts 58 could be arranged on the panel 50 forming the transverse side wall so that they likewise overlap the peripheral skirt of another panel (not shown). The upper surface of the support arms 30, 40 or the spacer 38 are fitted into the notches 51 or recesses 53. The notches 51 or recesses 53 can be formed at any portion of the deck panels 50 as long as they hold the deck panel 50 securely in place. Each deck panel 50 can be detached from the support arms 30, 40 and stored in a separate place. Each deck panel 50 preferably includes an anti slip plate, such as corrugated sheet of metal, perforated sheet of metal, or tread metal to provide traction as well as support. The perforated sheet of metal lessens weight of the deck panel 50 so that the user can more easily detach and store it. Light-weight magnesium perforated casting is preferably used for a deck panel 50 to provide the safe anti-slip surface. In one embodiment, the deck panels 50 need to be removed in order to close the side doors 14. In one embodiment, planks can be connected by a hinge so that a single folding platform replaces the two deck panels.

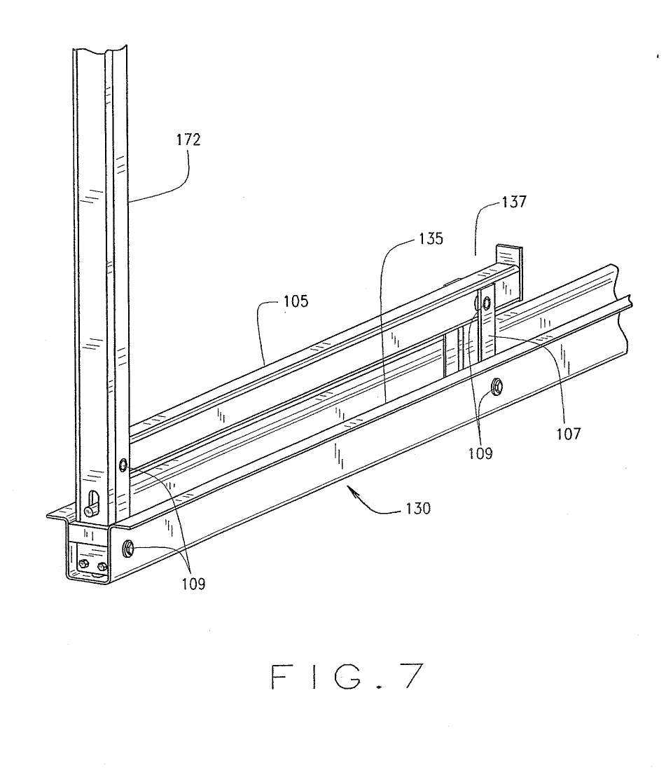

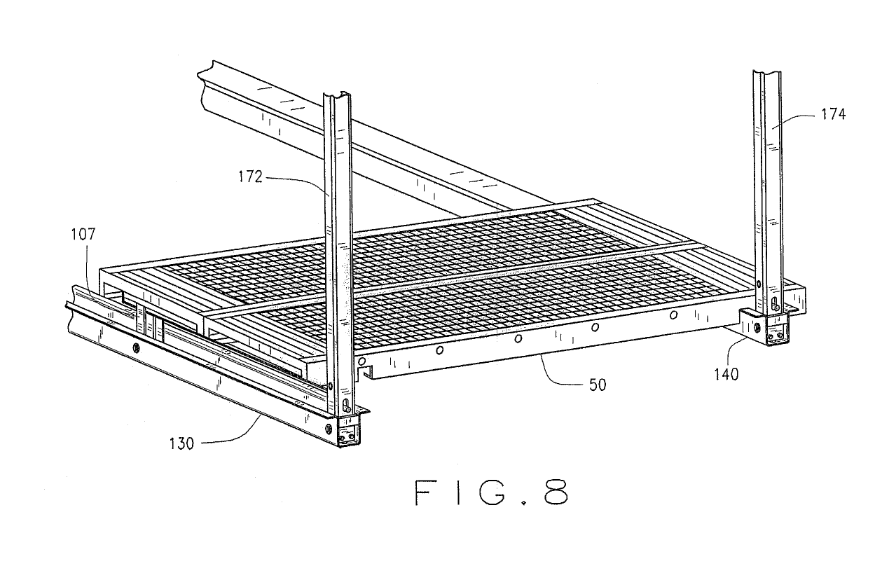

FIGS. 7 and 8 show a variation in which the supporting arm 130 consists of a mechanism 137, recognizable to those skilled in the art as a “four-bar linkage.” It consists of four rigid bars 130, 172, 105, 107, each attached to two others by hinges or pivots 109 to form a closed loop. Since each pivot 109 provides one rotational degree of freedom, the mechanism 137 works in a plane. The support arm 130 is a ground link, and the end post 172 and a link member 107 connected to the support arm 130 are grounded links. And, the load-bearing support member 105, which is not directly connected to the support arm 130, is the coupler link. The four-bar linkage mechanism 137 allows the load-bearing support member 105 to rise from or to collapse back into the groove 135. Those rigid bars 105, 107, 172 fit within the support arm 130. Referring to FIG. 8, in one embodiment, this support arm 130 with four-bar linkage, which elevates the deck panel 50, and the static structures of the support arms 130, 140, which does not elevate the deck panel 50, can be used simultaneously in a single platform installation. This is envisioned as particularly valuable when details of the trailer body construction permit one channel to be mounted directly below the decking of the floor structure 17 of the cargo body 12 but need the other channel to be mounted at some distance below the decking of the floor structure 17 resulting in different elevations. In one embodiment, the coupler link 105 and the ground links 107, 172 may include a multiplicity of hinge locations at the linking portion, which make it possible to quickly adjust the height of the deployed elevated deck panel 50 during installation or use.

In FIG. 5, the loading ramp 60 is shown. The ramp 60 is of importance for ease of transition of a cart, dolly or the like between the deck panel 50 and the ground. The ramp 60 includes a longitudinally extending flat walkway portion 61, having two side rails extended in a substantially perpendicular relationship with the flat base portion 61. At a leading end of the base 60 is an angled portion. The portion is for placement upon the top surface of the deck panel 50 and to anchor one end the ramp on the deck panel. The ramp 60 can mount to either front or rear end of the deck panel 50 or over the distal end of the deck panel 50. In one embodiment, the free edge of the deck panel is supported by legs or struts which reach to the ground. These legs may be realized as folding or telescoping attachments to the support arms, or as separate pieces which are attached during or after deployment of the deck panel (not shown).

As will become apparent in the following description, the simple structure of the present invention allows a level of flexibility and versatility that has never been achieved in loading systems for vehicles.

The operation of the devices are as follows. As seen in FIGS. 1 and 2, when it is desired to move the loading apparatus 11 from its stored position to its operating position, the movement can be performed in two steps. The first movement is an extension of each of the support arms 30, 40 from their retracted positions laterally of the trailer body 12 outwardly from the channels 22, 24 to their extended position shown on FIG. 2 to provide cantilevered support of the deck panel 50. This is accomplished by application of pulling force on the grips 34, 44 of the supports arms 30, 40. Thereupon, the support arms 30, 40 are positioned for operation. Complete withdrawal is prevented by the deck panel 50 or a latch. In one embodiment, at least one side of the deck panel 50 can be mounted on the spacer 38 to hold the deck panel 50 in a substantially horizontal position. In one embodiment, the end posts 72, 74 can also be detachably mounted on the distal end portion of each support arm 30, 40 to hold the deck panels 50 and provided with a guard rail or cable if desired. Thereupon, the deck panels 50 can be mounted on the support arms 30, 40. After using the loading apparatus 11 to load articles or objects onto the floor structure 17 of the trailer body 12 and/or unload articles or objects from the trailer body 12, the apparatus 11 is returned to its stored position by reversing the prior steps.

From the drawings and the above description, it is apparent that a loading and unloading apparatus constructed in accordance with the invention, provides desirable features and advantages. For example, the apparatus is more manageable by dividing it into interchangeable panels 50. As another important feature, the apparatus is adapted to mount on the under side of a frameless body without requiring any modification of the structural members of the body 12. In addition, the apparatus provides an adjustable platform space of the platform deck over the clearance space to provide for rolling carts or other articles with support wheels smoothly between the floor structure and the platform deck.

An optional feature of the present invention is the use of the guard rail for safety. (Not shown). In order to avoid inadvertent falling-off of the deck panels 50, the deck panels 50 may include handrail supports attached to the outer sides. These handrail supports may be configured to lock horizontal handrails (not shown) in place. The horizontal handrail may be detachably mounted along the outer surface of the deck panels 50. The handrail prevents the cart from rolling off the rear edge of the platform. Further, the trailer doors will not close with the loading apparatus in place for safety.

Although a several embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow. The scope of the disclosure is not intended to be limited to the embodiments shown herein, but is to be accorded the full scope consistent with the claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A loading and unloading apparatus for a trailer body, comprising:
a plurality of elongate support arms;
a plurality of channels, the channels being mounted to a floor structure of the trailer body allowing said each support arm to be mounted in a respective said channel and to move longitudinally of said channels between a stored position and an operating position;
at least one deck panel, the deck panel having opposite end edge portions and the deck panel being mounted on said support arms; and
means for removably mounting said opposite end edge portions to said support arms, wherein said opposite end edge portions are mounted on said support arms.

2. A loading and unloading apparatus for a trailer body as set forth in claim 1, further comprising a ramp mounted to one of said support arms.

3. A loading and unloading apparatus for a trailer body as set forth in claim 1, wherein the plurality of elongate support arms are two generally parallel spaced apart support arms.

4. A loading and unloading apparatus for a trailer body as set forth in claim 3, wherein one support arm is lower than the other support arm.

5. A loading and unloading apparatus for a trailer body as set forth in claim 4, further comprising means for supporting the deck panel.

6. A loading and unloading apparatus for a trailer body as set forth in claim 1, wherein the elongate support arms further comprise grips affixed at the distal end of said elongate support arms.

7. A loading and unloading apparatus for a trailer body as set forth in claim 1, further comprising at least one post projecting upwardly from the distal end portion of each said support arm, the post being mounted on the support arm and holding the deck panel in a fixed position.

8. A loading and unloading apparatus for a trailer body, comprising:
at least one deck panel having two opposite end edge portions;
means for supporting said deck panel;
at least one channel under the floor structure of the trailer body allowing said supporting means to be mounted in the channel and to move longitudinally of the channel between a stored position and an operating position; and
means for removably mounting said opposite end edge portions to said supporting means, wherein said opposite end edge portions are detachably mounted on said supporting means.

9. A loading and unloading apparatus for a trailer body as set forth in claim 8, further comprising a ramp mounted to said support arm.

10. A loading and unloading apparatus for a trailer body as set forth in claim 8, wherein the means for supporting said deck panel further comprise grips affixed at the distal end of said means for supporting said deck panel.

11. A loading and unloading apparatus for a trailer body as set forth in claim 8, further comprising at least one post projecting upwardly from the distal end portion of each said support arm, the post being mounted on the support arm and holding the deck panel in a fixed position.

12. A loading and unloading apparatus for a trailer body having a side wall with a doorway, comprising:
a set of generally parallel spaced channels extending horizontally within the floor structure of the trailer body;
a plurality of elongate support arms mounted in said channels;
at least one deck panel detachably mounted on the support arms; and
means for removably mounting at least one said deck panel to said support arms, wherein said channels allow said support arms to be mounted in the channels and move longitudinally between a stored position and an operating position.

13. A loading and unloading apparatus for a trailer body as set forth in claim 12, further comprising a ramp removably mounted to said support arm.

14. A loading and unloading apparatus for a trailer body as set forth in claim 12, wherein the plurality of elongate support arms are two generally parallel spaced support arms.

15. A loading and unloading apparatus for a trailer body as set forth in claim 14, wherein one support arm is lower than the other support arm.

16. A loading and unloading apparatus for a trailer body as set forth in claim 15, further comprising at least one means for supporting at least one the deck panel in a horizontal position, the means for supporting the at least one deck panel being mounted on the support arm.

17. A loading and unloading apparatus for a trailer body as set forth in claim 12, wherein the elongate support arms further comprising grips affixed at the distal end of said elongate support arms.

18. A loading and unloading apparatus for a trailer body as set forth in claim 12, further comprising at least one post projecting upwardly from the distal end portion of each said support arm, the post being mounted on the support arm and holding the deck panel in a fixed position.

19. A loading and unloading apparatus for a trailer body, comprising:
a plurality of elongate support arms;
a plurality of channels, the channels being formed within a floor structure of the trailer body allowing each said support arm to be mounted in a respective said channel and to move longitudinally between a stored position and an operating position;
at least one load-bearing support member, the load-bearing support member being connected to a top portion of at least one of said elongate support arms, the load-bearing support member being positioned over said elongate support arm; and
at least one deck panel, the deck panel having opposite end edge portions and the at least one deck panel being mounted to said load-bearing support member.

20. A loading and unloading apparatus for a trailer body as set forth in claim 19, wherein one support arm is lower than the other support arm.

21. A loading and unloading apparatus for a trailer body as set forth in claim 19, wherein the load-bearing support member is stored in an upwardly opening groove formed in said elongate support arm.
